(19) United States
(12) Patent Application Publication
(10) Pub. No.: US 2011/0209431 A1
(43) Pub. Date: Sep. 1, 2011

(54) EASY-TO-BE-ASSEMBLED DOUBLE-FACE BEZEL STRUCTURE AND ASSEMBLING METHOD THEREOF

(75) Inventor: Wen-Chin TSAI, Hukou Township (TW)

(73) Assignee: JOCHU THCHNOLOGY CO., LTD., Hsin Chu County (TW)

(21) Appl. No.: 13/088,089

(22) Filed: Apr. 15, 2011

Related U.S. Application Data
(63) Continuation-in-part of application No. 11/823,448, filed on Jun. 26, 2007, now abandoned.

(30) Foreign Application Priority Data
Dec. 20, 2006 (TW) 95148027
Apr. 10, 2007 (TW) 96112431

(51) Int. Cl. E04C 2/38; B23P 19/02

(52) U.S. Cl. 52/656.9; 29/525

(57) ABSTRACT

An easy-to-be-assembled double face bezel structure includes at least one first frame elements having a top joint portion and a lateral joint portion with built-on rivet units; at least one second frame element having a top joint portion and a lateral joint portion with rivet holes penetrating therethrough. The method for assembling the easy-to-be-assembled double-face bezel structure involves placing the built-on rivet units into the corresponding rivet holes whereby the top joint portions and the lateral joint portions of the first frame element and the second frame element are aligned, and punching each rivet unit so that it tightly joins with the corresponding rivet hole. No further welding or adhesion is necessary for joining the first frame element and the second frame element. The double-face bezel structure not only provides double-face protection, but also provides a stronger structural connection of the first frame element and the second frame element.

### RELATED APPLICATIONS

This application is a Continuation-In-Part patent application of Ser. No. 11/823,448 filed on 26 Jun. 2007, currently pending.

### BACKGROUND OF THE INVENTION

1. Field of the Invention

The present invention relates to a bezel of a display and, more especially, to an easy-to-be-assembled double-face bezel of the display and its assembling method.

2. Description of the Prior Art

Generally, the prior bezel of the plane display is directly formed by one-step punching the metal material to form the one-piece-form bezel. Owing to the bigger size of the bezel, it needs the punching equipment and the mold with the bigger size and specification for one-step punching; as a result, the cost will be increased. Besides, the mold is bulky, the operation is difficult and there will be a lot of waste material from the punching step. The structure of the one-piece-form bezel is stronger; however, the cost correspondingly rises.

Hence, it is more common to use a plurality of frame elements to constitute a rectangular bezel for fixing the panel and the metal bezel or frame of the backlight module. Referring to FIG. 1A, FIG. 1B, FIG. 1C, FIG. 1D and FIG. 1E, those are partial schematic diagrams of the bezel structure of the display panel of the Taiwan Patent Issue No. M285175. The disclosed bezel is composed of a plurality of frame elements and has a containing space 1a.

Following the foregoing description, frame elements 10 are joined with each other at their ends. At the end of the frame element, there is formed a joint portion 11 with a reduced thickness. A semicircle concave portion 11a and a protruding portion 11b are respectively formed on the joint portions 11. Further, there are a mortise 12a and a corresponding tenon 12b respectively arranged on joint portions 11 to align and to tenon with each other. At the outside edge of the frame element 10, a vertical portion 13 is formed to surround and to constitute the containing space 1a. In the prior art, the disclosed bezel structure must be completed by utilizing a welding step, or an adhesion step to join the joint portions 11.

### SUMMARY OF THE INVENTION

In order to solve the foregoing problems, one object of the present invention is to provide an easy-to-be-assembled double-face bezel structure. The double-face bezel structure is constructed with frame elements that have top and lateral joint portions with built-on rivet units and rivet holes that not only allow easy alignment of the joint portions of the frame elements to be joined, but also can be tightly joined, and is therefore more sturdy. Also, one of the frame element has a built-on connecting face to simplify reinforcement of the structural connection of the frame elements.

Another object of the present invention is to provide a method for assembling the easy-to-be-assembled double-face bezel structure. According to the present invention, the joint portions of the frame elements of the easy-to-be-assembled double face bezel structure to be joined can be easily aligned by placing the rivet units into the corresponding rivet holes, and then can be tightly joined by a punching step. No further welding or adhesion is necessary. While the size of a bezel increases with the growing dimension of a display, transporting the bezel becomes increasingly harder. Such simplified assembling process allows the bezel to be transported in pieces to the display panel assembling vendor and assembled on the vendor's site by a punching step only.

To achieve the foregoing purposes, according to one embodiment, the easy-to-be-assembled double-face bezel structure includes at least one first frame element and at least one second frame element, each being one-piece. The first frame element comprises a top face; a lateral face connected with the top face on one edge; a connecting face, if not in the second frame element, connected with at least one of the top face and the lateral face on another edge intersecting with the edge; a top rivet unit protruding from a first top joint portion on one end of the top face; and a lateral rivet unit protruding from a first lateral joint portion being the connecting face if there, or the first lateral joint portion on one end of the lateral face. The second frame element comprises a top face; a lateral face connected with the top face on one edge; a connecting face, if not in the first frame element, connected with at least one of the top face and the lateral face on another edge intersecting with the edge; a top rivet hole protruding from a second top joint portion on one end of the top face; and a lateral rivet hole protruding from a second lateral joint portion on one end of the lateral face, or the second lateral joint portion being the connecting face if there. The top rivet unit and the top rivet hole, and the lateral rivet unit and the lateral rivet hole are respectively at corresponding positions so as to be tightly joined for joining the first top joint portion with the second top joint portion and the first lateral joint portion with the second lateral joint portion.

According to another embodiment, a method for assembling the aforementioned easy-to-be-assembled double face structure consists of the following steps: placing the rivet units into the corresponding rivet holes; and punching each of the rivet units such that the rivet unit fill the corresponding rivet hole.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A, FIG. 1B, FIG. 1C, FIG. 1D and FIG. 1E are partial schematic diagrams of the bezel structure of the display panel of the Taiwan Patent Issue No. M285175;

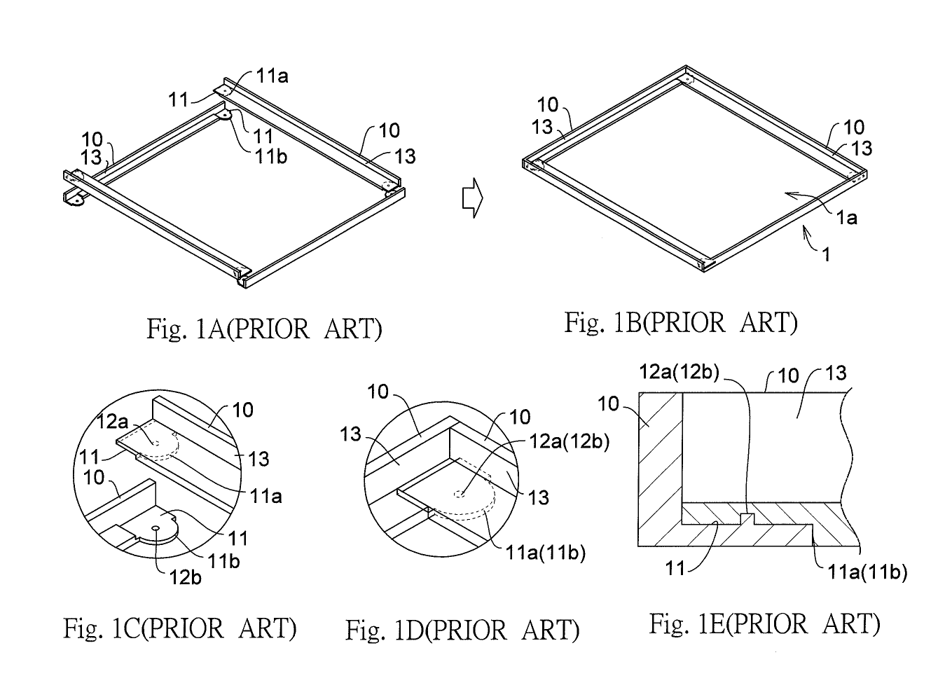

FIG. 2A, FIG. 2B, FIG. 2C and FIG. 2D are partial 3-dimentional schematic diagrams of the easy-to-be-assembled double-face bezel structure in accordance with one embodiment of the present invention;

FIG. 3A, FIG. 3B, FIG. 3C and FIG. 3D are 3-dimentional schematic diagrams illustrating the joining process of the top faces of the first frame element and the second frame element of the easy-to-be-assembled double-face bezel structure in accordance with one embodiment of the present invention;

FIG. 4A, FIG. 4B, FIG. 4C and FIG. 4D are schematic sectional view diagrams of FIG. 3A, FIG. 3B, FIG. 3C and FIG. 3D, respectively;

FIG. 5A, FIG. 5B, FIG. 5C and FIG. 5D are schematic sectional view diagrams illustrating the joining process of the lateral faces of the first frame element and the second frame element of the easy-to-be-assembled double-face bezel structure in accordance with one embodiment of the present invention;

FIG. 6 is a partial 3-dimentional schematic diagram of the easy-to-be-assembled double-face bezel structure in accordance with another embodiment of the present invention;

FIG. 7A is a schematic top view diagram of the easy-to-be-assembled double-face bezel structure in accordance with one embodiment of the present invention;

FIG. 7B is a schematic sectional view diagram taken along line A-A in FIG. 7A;

FIG. 8A is a schematic top view diagram of the easy-to-be-assembled double-face bezel structure in accordance with one embodiment of the present invention;

FIG. 8B is a schematic sectional view diagram taken along line B-B in FIG. 8A;

FIG. 9 is a schematic top view diagram of the easy-to-be-assembled double-face bezel structure in accordance with one embodiment of the present invention;

FIG. 10A is a schematic partial sectional view diagram of the top face of the easy-to-be-assembled double-face bezel structure in accordance with one embodiment of the present invention; and

FIG. 10B is a schematic partial sectional view diagram of the lateral face of the easy-to-be-assembled double-face bezel structure in accordance with one embodiment of the present invention.

### DETAILED DESCRIPTION OF THE INVENTION

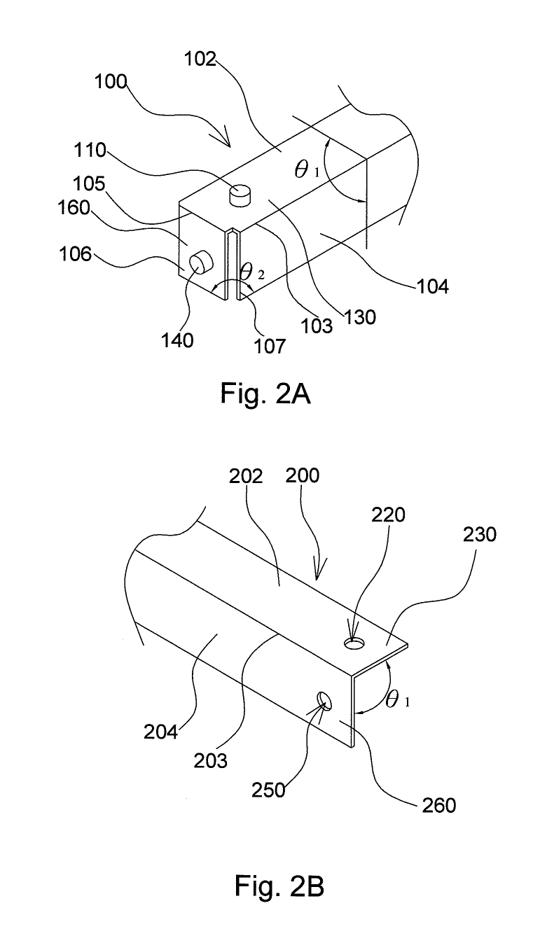

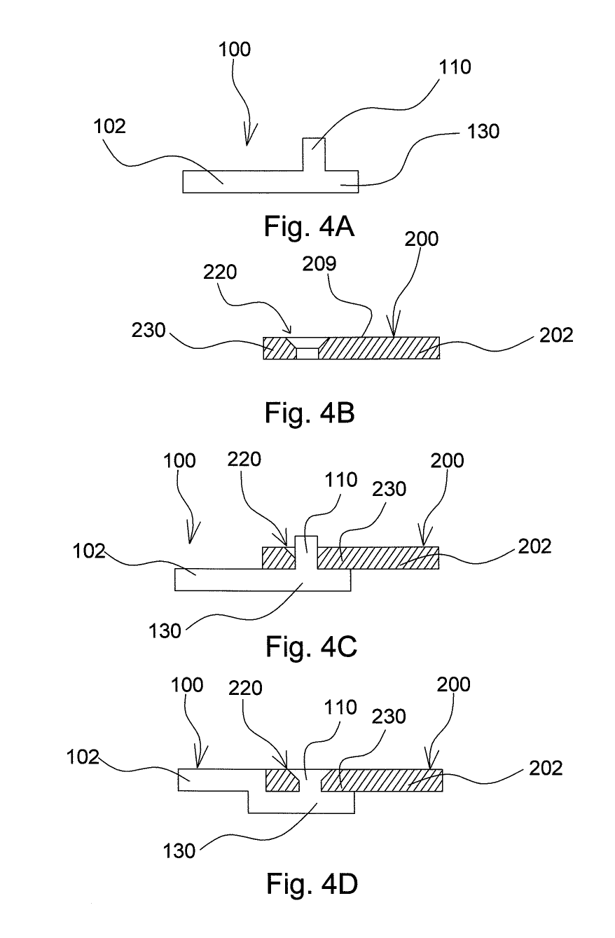

FIG. 2A, FIG. 2B, FIG. 2C and FIG. 2D are partial 3-dimentional schematic diagrams of an easy-to-be-assembled double-face bezel structure in accordance with one embodiment of the present invention. FIG. 6 is a partial 3-dimensional schematic diagram of an easy-to-be-assembled double-face bezel structure in accordance with another embodiment. Referring to FIG. 2A and FIG. 2B and FIG. 6, the easy-to-be-assembled double-face bezel structure includes at least one first frame element 100 and at least one second frame element 200, each being one-piece. Both the first frame element 100 and second frame element 200 have a top face 102, 202 and a lateral face 104, 204 connected with the top face 102, 202 on one edge 103, 203. Either the first frame element 100 or the second frame element 200 has a connecting face 106, 206 connected with the top face 102, 202 and/or the lateral face 104, 204 on another edge 105, 205 intersecting with the edge 103, 203. In the embodiment illustrated in FIG. 2A and FIG. 2B, the connecting face 106 is connected with the top face 102 of the first frame element 100 on the edge 105 intersecting with the edge 103. In the embodiment illustrated in FIG. 6, the connecting face 206 is connected with the top face 202 of the second frame element 200 on the edge 205 intersecting with the edge 203. Referring to FIG. 2A and FIG. 2B and FIG. 6, it should be understandable that the connecting face 106, 206 may alternatively or also be connected with the lateral faces 104, 204 on another edge 107, 207 intersecting with the edge 103, 203. Inherently, the top face 102, 202 and the lateral face 104, 204 have a first included angle θ₁ therebetween, so that the assembled bezel structure borders a display on the top as well as along the sides. According to an embodiment, the connecting face 106, 206 and the lateral face 104, 204 have a second included angle θ₂ therebetween, which is substantially the same as the first included angle θ₁.

Referring to FIG. 2A and FIG. 6, a first top joint portion 130 and at least one top rivet unit 110 are simultaneously formed on an end of the top face 102 of the first frame element 100, and a first lateral joint portion 160 and at least one lateral rivet unit 140 are simultaneously formed on the connecting face 106 being part of the first frame element 100 as illustrated in FIG. 2A or on an end of the lateral face 104 of the first frame element 100 as illustrated in FIG. 6. The top rivet unit 110 protrudes from the first top joint portion 130 and the lateral rivet unit 140 protrudes from the first lateral joint portion 160. Referring to FIG. 2B and FIG. 6, a second top joint portion 230 and at least one top rivet hole 220 are simultaneously formed on an end of the top face 202 of the second frame element 200, and a second lateral joint portion 260 and at least one lateral rivet hole 250 are simultaneously formed on an end of the lateral face 204 of the second frame element 200 as illustrated in FIG. 2B or on the connecting face 206 being part of the second frame element 200 as illustrated in FIG. 6. The top rivet hole 220 and the lateral rivet hole 250 penetrate through the second top joint portion 230 and the second lateral joint portion 260 respectively. Referring to FIG. 2C and FIG. 2D, the top rivet unit 110 and the top rivet hole 220, and the lateral rivet unit 140 and the lateral rivet hole 250 are respectively at corresponding positions. When the first frame element 100 is assembled with the second frame element 200, the top rivet unit 110 of the first top joint portion 130 is placed into the top rivet hole 220 of the second top joint portion 230 and the lateral rivet unit 140 of the first lateral joint portion 160 is placed into the lateral rivet hole 250 of the second lateral joint portion 260, and the first top joint portion 130 and the second top joint portion 230, and the first lateral joint portion 160 and the second lateral joint portion 260 are automatically aligned, respectively. The rivet units 110, 140 can be tightly joined with the rivet holes 220, 250 so as to join the joint portions 130 and 230, 160 and 260, as described more fully below. After being assembled, the bezel structure would have two faces on each of four sides, one being the top face and the other being the lateral face, thereby forming a double-face bezel structure.

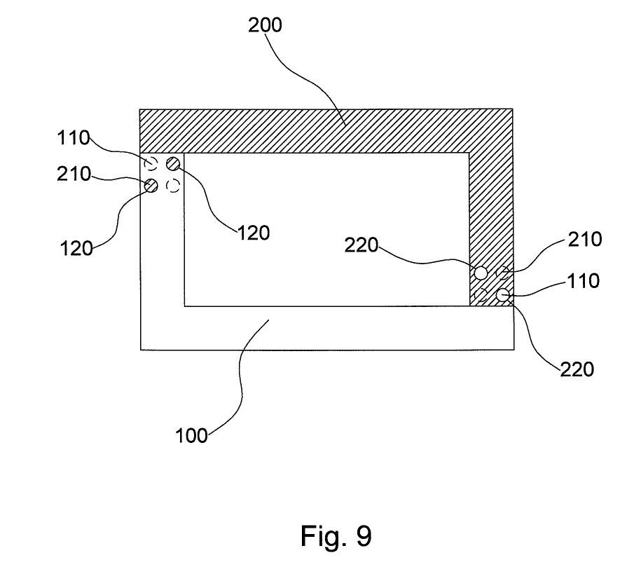

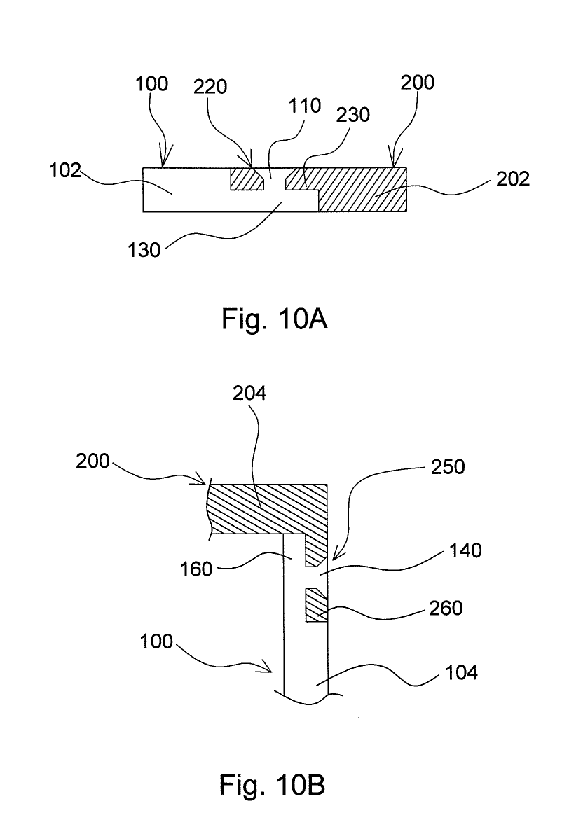

According to an embodiment as illustrated in FIG. 10A and FIG. 10B, when the first top joint portion 130 is joined with the second top joint portion 230, a combined thickness of the first top joint portion 130 and the second top joint portion 230 is the same as a thickness of the top faces 102, 202 of the first frame element 100 and the second frame element 200. In other words, the first top joint portion 130 and the second top joint portion 230 form a half-lap joint. When the first lateral joint portion 160 is joined with the second lateral joint portion 260, a combined thickness of the first lateral joint portion 160 and the second lateral joint portion 260 is the same as a thickness of the lateral faces 104, 204 of the first frame element 100 and the second frame element 200. In other words, the first lateral joint portion 160 and the second lateral joint portion 260 form a half-lap joint. In this way, the double-face bezel structure has uniform thicknesses for both the top face and the lateral face upon being assembled, and hence similar to have one-piece-form and can fit more closely to the display.

Referring to FIG. 2C and FIG. 2D, a method for assembling the aforementioned easy-to-be-assembled double-face bezel structure consists the steps of placing the top rivet unit 110 into the top rivet hole 220, and the lateral rivet unit 140 into the lateral rivet hole 250; and a punching step utilized to punch the top rivet unit 110 to fill the top rivet hole 220, and to punch the lateral rivet unit 140 to fill the lateral rivet hole 250 so as to tightly join the first frame element 100 and the second frame element 200.

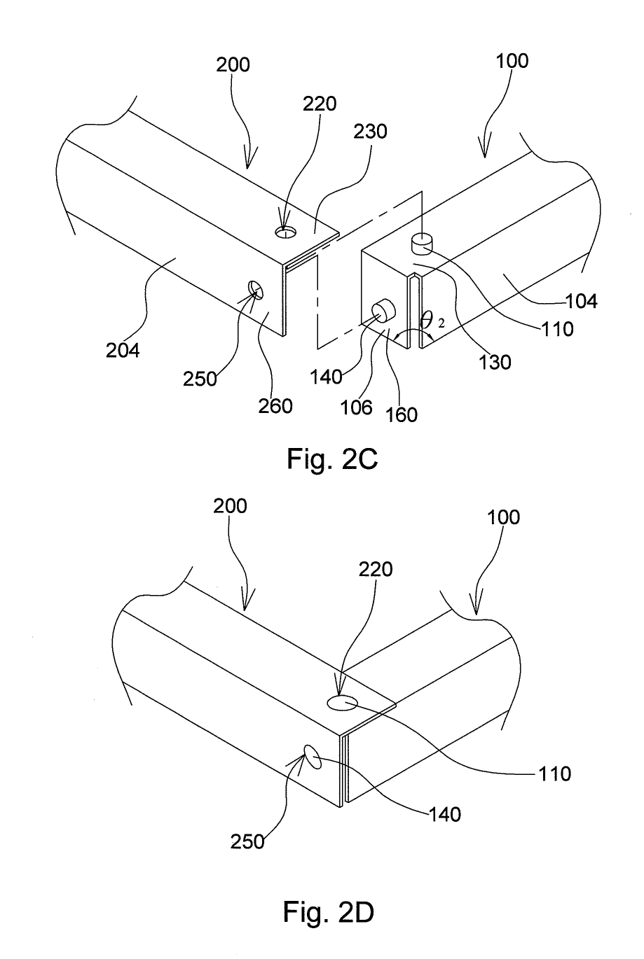

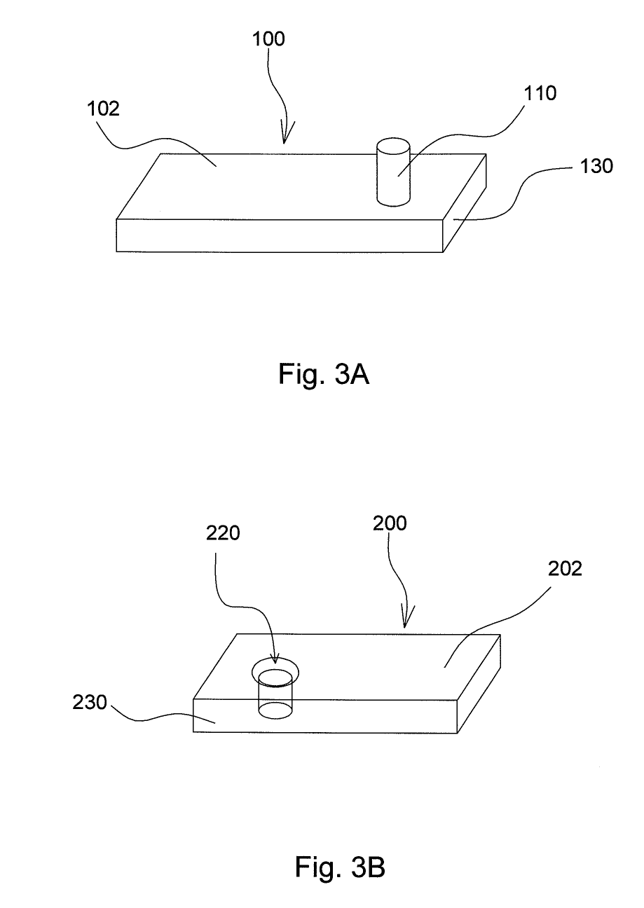

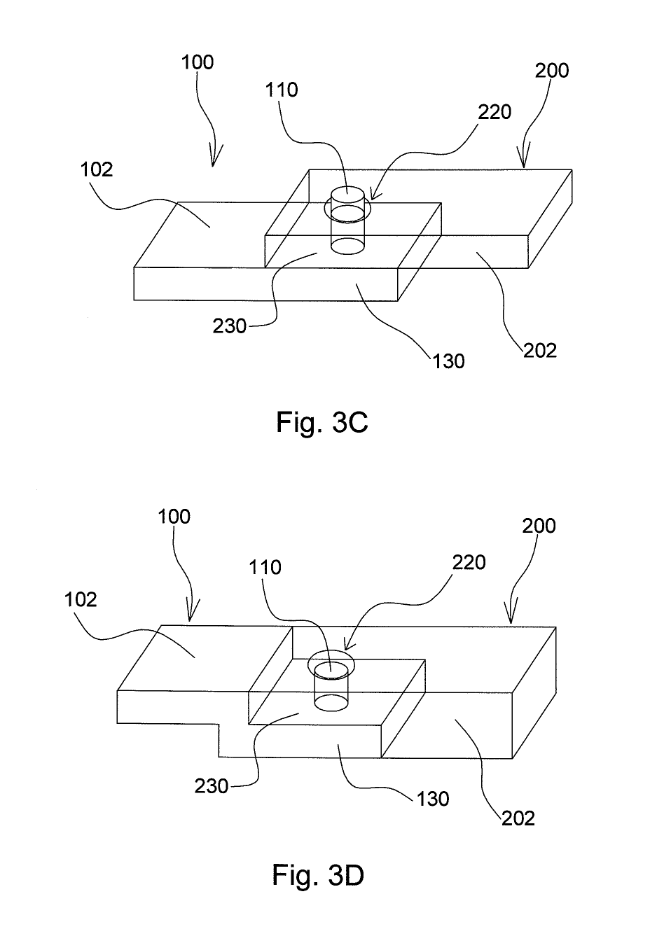

Below focus on describing the method of making and assembling the first frame element and the second frame element. FIG. 3A, FIG. 3B, FIG. 3C, and FIG. 3D are 3-dimensional schematic diagrams and FIG. 4A, FIG. 4B, FIG. 4C and FIG. 4D are schematic sectional view diagrams illustrating the joining process of the top faces of the first frame element and the second frame element. FIG. 5A, FIG. 5B, FIG. 5C and FIG. 5D are schematic sectional view diagrams illustrating the joining process of the lateral faces of the first frame element and the second frame element. Since the 3-dimensional schematic diagrams of the lateral faces of the first frame element and the second frame element are similar to the top faces, they are omitted here.

Referring to FIG. 3A and FIG. 4A, first, a first top joint portion 130 and at least one top rivet unit 110 are simultaneously formed on an end of a top face 102 of the first frame element 100, wherein the first top joint portion 130 and the top rivet unit 110 are simultaneously formed by a forging step and the top rivet unit 110 protrudes from the first top joint portion 130. Referring to FIG. 5A, the first lateral joint portion 160 and at least one lateral rivet unit 140 are simultaneously formed on an end of the lateral face 104 of the first frame element 100 by a forging step, and the lateral rivet unit 140 protrudes from the first lateral joint portion 160. Referring to FIG. 3B and FIG. 4B, a second top joint portion 230 and at least one top rivet hole 220 are simultaneously formed on an end of the top face 202 of the second frame element 200 by a punching step. The top rivet hole 220 penetrates through the second top joint portion 230. Referring to FIG. 5B, a second lateral joint portion 260 and at least one lateral rivet hole 250 are simultaneously formed on an end of the lateral face 204 of the second frame element 200 by a punching step, wherein the lateral rivet hole 250 penetrates through the second lateral joint portion 260. Referring to FIG. 4B and FIG. 5B, according to an embodiment, the rivet holes 220, 250 are respectively enlarged toward a non-joined surface 209 of the top face 202 where the top rivet hole 220 is disposed and a non-joined surface 211 of the lateral face 204 where the lateral rivet hole 250 is disposed. For example, the rivet holes 220, 250 may each have a countersink shape. Referring to FIG. 4C and FIG. 5C, according to an embodiment, a height of the top rivet unit 110 is larger than a depth of the top rivet hole 220, and a height of the lateral rivet unit 140 is larger than a depth of the lateral rivet hole 250. According to an embodiment, the first frame element 100 and the second frame element 200 are made of metal.

To continue the above explanation and referring to FIG. 3C and FIG. 4C and FIG. 5C, when assembling the first frame element 100 and the second frame element 200, the top rivet unit 110 is correspondingly placed into the top rivet hole 220 so as to align the first top joint portion 130 of the first frame element 100 and the second top joint portion 230 of the second frame element 200, and the lateral rivet unit 140 is correspondingly placed into the lateral rivet hole 250 so as to align the first lateral joint portion 160 of the first frame element 100 and the second lateral joint portion 260 of the second frame element 200. Then, referring to FIG. 3D and FIG. 4D, the first top joint portion 130 of the first frame element 100 and the second top joint portion 230 of the second frame element 200 are tightly joined by a punching step that punches the portion of the top rivet unit 110 extended out of the second top joint portion 230 as shown in FIG. 3C and FIG. 4C to fill the enlarged portion of the top rivet hole 220. Referring to FIG. 5D, the first lateral joint portion 160 of the first frame element 100 and the second lateral joint portion 260 of the second frame element 200 are tightly joined by a punching step that punches the portion of the lateral rivet unit 140 extended out of the second lateral joint portion 260 as shown in FIG. 5C to fill the enlarged portion of the lateral rivet hole 250.

Referring to FIG. 2C, FIG. 4D, and FIG. 5D at the same time, in the present embodiment, the structural strength of the easy-to-be-assembled double-face bezel structure is enhanced by joining the first frame element 100 and the second frame element 200 both at the first top joint portion 130 and the second top joint portion 230 of the top faces 102, 202, and at the first lateral joint portion 160 and the second lateral joint portion 260 of the lateral faces 104, 204. Further, referring to FIG. 2C, in this embodiment, the connecting face 106 where the first lateral joint portion 160 is located forms the second included angle θ₂ with the lateral face 104. The second included angle θ₂ is an adequate angle so as to align the connecting face 106 of the first frame element 100 and the lateral face 204 of the second frame element 200 to strengthen the structural connection between the first frame element 100 and the second frame element 200. Moreover, as illustrated in FIG. 4D, the first top joint portion 130 and the second top joint portion 230 of the top faces 102, 202 are tightly joined by the top rivet unit 110 filling the enlarged portion of the top rivet hole 220, and as illustrated in FIG. 5D, the first lateral joint portion 160 and the second lateral joint portion 260 of the lateral faces 104, 204 are tightly joined by the lateral rivet unit 140 filling the enlarged portion of the lateral rivet hole 250.

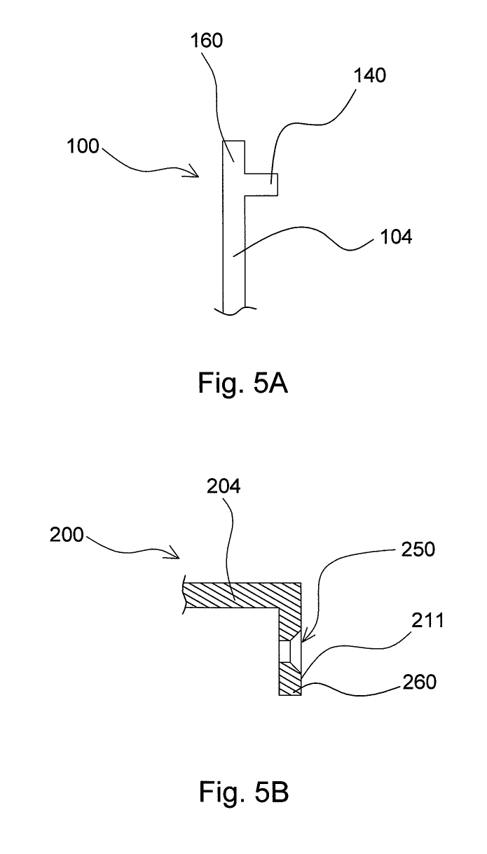

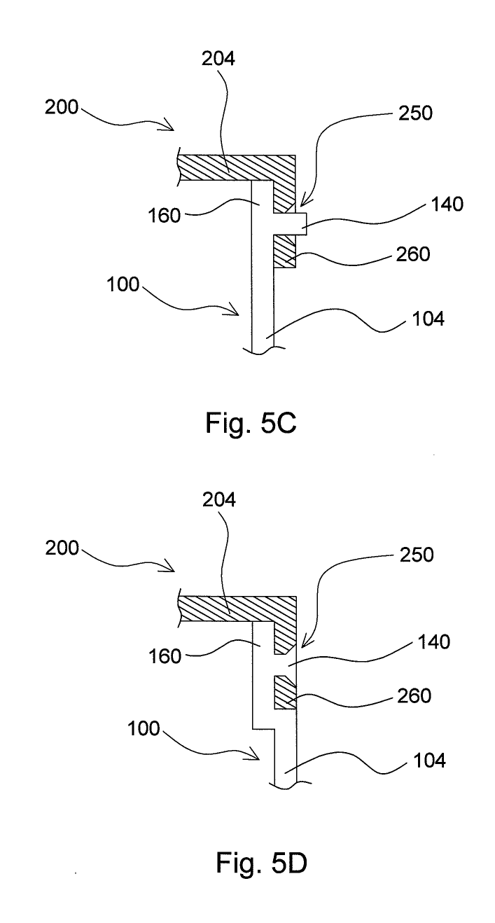

FIG. 7A is a top view diagram schematically illustrating a rectangular double-face bezel structure according to an embodiment, and FIG. 7B is a sectional view diagram taken along line A-A in FIG. 7A. Referring to FIG. 7A, according to an embodiment, a rectangular double-face bezel structure includes two strip-shaped first frame elements 100 and two strip-shaped second frame element 200 assembled together. Referring to FIG. 7A and FIG. 7B, the first frame element 100 has two first top joint portions 130 respectively on both ends of the first frame element 100, and has two first lateral joint portions 160 respectively on both ends of the first frame element 100. The second frame element 200 has two second top joint portions 230 respectively on both ends of the second frame element 200, and has two second lateral joint portions 260 respectively on both ends of the second frame element 200. At each of four corners of the double-face bezel structure, both the first top joint portion 130 and the second top joint portion 230, and the first lateral joint portion 160 and the second lateral joint portion 260 are tightly joined. According to an embodiment, there may be an additional top rivet unit 110 on the first top joint portion 130 to penetrate and fill an additional top rivet hole 220 on the second top joint portion 230, and an additional lateral rivet unit 140 on the first lateral joint portion 160 to penetrate and fill an additional lateral rivet holes 250 on the second lateral joint portion 260 so as to further reinforce the structural connection of the first frame element 100 and the second frame element 200.

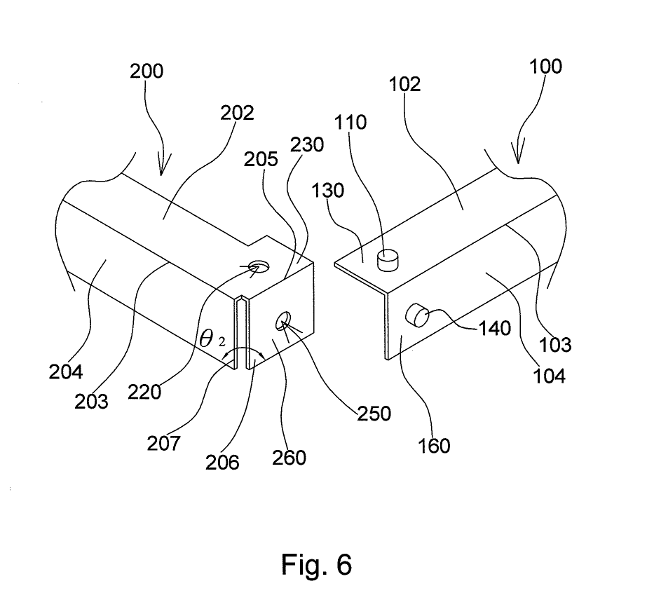

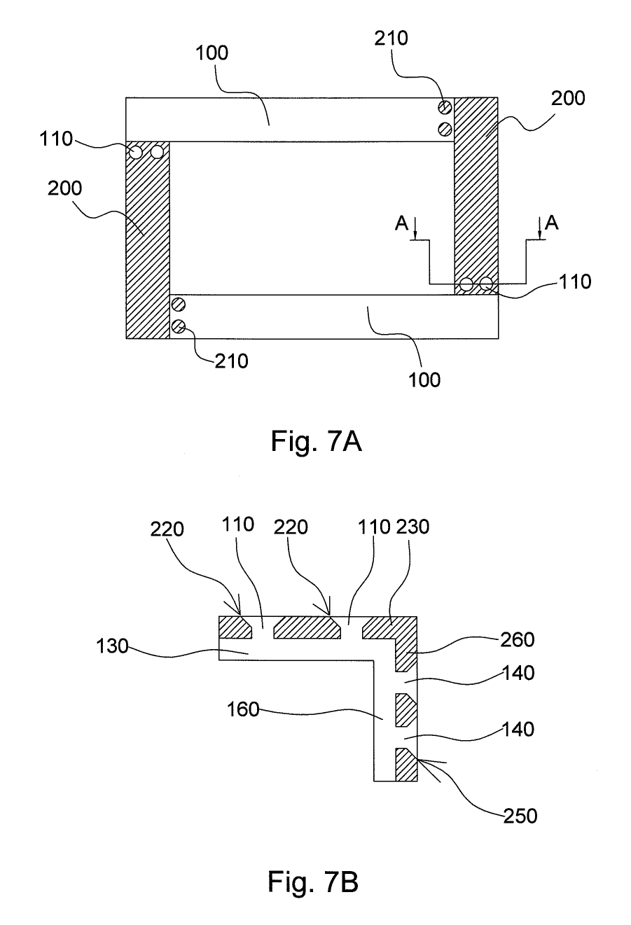

FIG. 8A is a top view diagram schematically illustrating a rectangular double-face bezel structure according to another embodiment, and FIG. 8B is a sectional view diagram taken along line B-B in FIG. 8A. Referring to FIG. 8A, according to an embodiment, a rectangular double-face bezel structure includes one rectangular U-shaped first frame element 100 and one rectangular U-shaped second frame element 200 assembled together. Referring to FIG. 8A and FIG. 8B, the first frame element 100 has two first top joint portions 130 respectively on both ends of the first frame element 100, and has two first lateral joint portions 160 respectively on both ends of the first frame element 100. The second frame element 200 has two second top joint portions 230 respectively on both ends of the first frame element 100, and has two second lateral joint portions 260 respectively on both ends of the first frame element 100. At each of the two connected ends of the first frame element 100 and the second frame element, both the first top joint portion 130 and the second top joint portion 230, and the first lateral joint portion 160 and the second lateral joint portion 260 are tightly joined. According to an embodiment, on the first top joint portion 130, besides the top rivet unit 110 arranged thereon, there can further be arranged at least one additional top rivet hole 120 on the first top joint portion 130 by utilizing a punching step. The additional top rivet hole 120 is enlarged toward a non-joined surface 109 of the first top joint portion 130. Correspondingly, at least one additional top rivet unit 210 is disposed on the second top joint portion 260 by utilizing a forging step to penetrate the additional top rivet hole 120. Further, on the first lateral joint portion 160, besides the lateral rivet unit 140 arranged thereon, there can further be arranged at least one additional lateral rivet hole 150 on the first top joint portion 160 by utilizing a punching step. The additional lateral rivet hole 150 is enlarged toward a non-joined surface 111 of the first lateral joint portion 160. Correspondingly, at least one additional lateral rivet unit 240 is disposed on the second lateral joint portion 260 by utilizing a forging step to penetrate the additional lateral rivet hole 150. In this way, the first top joint portion 130 and second top joint portion 230 are interlocked, and the first lateral joint portion 160 and second lateral joint portion 260 are interlocked.

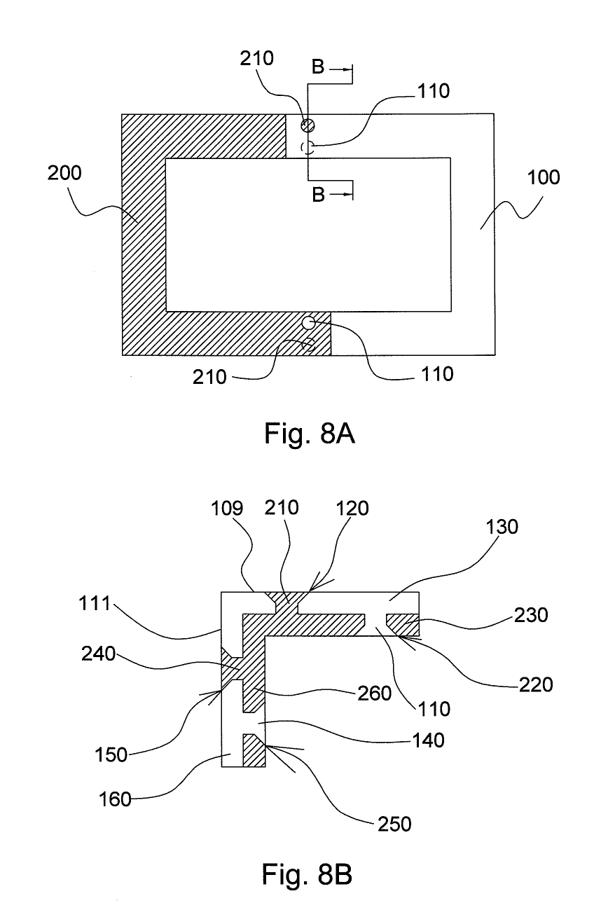

FIG. 9 is a top view diagram schematically illustrating a rectangular double-face bezel structure according to another embodiment. Referring to FIG. 9, in another embodiment, a rectangular double-face bezel structure includes one L-shaped first frame element 100 and one L-shaped second frame element 200 assembled together. In this embodiment, there are a plurality of top rivet holes 120 and a plurality of top rivet units 110 formed on the first frame element 100, and a plurality of top rivet holes 220 and a plurality of top rivet units 210 formed on the second frame element 200 to tightly join the first frame element 100 with the second frame element 200. Since the cross-section view of the rectangular bezel structure in FIG. 9 is the same as that of FIG. 8B, it is omitted here.

According to the above embodiments, the frame elements of the double-face bezel structure can be aligned easily by placing the rivet units into the corresponding rivet holes and can be tightly joined by a punching step. The conventional joining techniques such as welding, or adhesion are no longer necessary and only a common punching equipment is required for assembly. The built-on connecting face of the frame element simplifies reinforcement of the structural connection of the frame elements compared to, for example, an extra connecting piece holding the frame elements together which may require additional alignment. While the size of a display gets larger, transporting the bezel for the large size display becomes more difficult. With such a simplified assembling process, frame elements of the bezel can be delivered to the display panel assembling vendor, and assembled on the vendor's site by punching only. Also, the double-face bezel structure not only provides a double-face protection for the delicate display, but also provides a more sturdy structure that have tightly joined top joint portions and lateral joint portions for each connected ends of the frame elements.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. An easy-to-be-assembled double-face bezel structure, comprising:
at least one first frame element and at least one second frame element, each being one-piece, wherein
the first frame element comprises:
a top face;
a lateral face connected with the top face on one edge;
a connecting face, if not in the second frame element, connected with at least one of the top face and the lateral face on another edge intersecting with the edge;
a top rivet unit protruding from a first top joint portion on one end of the top face; and
a lateral rivet unit protruding from a first lateral joint portion being the connecting face if there, or the first lateral joint portion on one end of the lateral face; and
the second frame element comprises:
a top face;
a lateral face connected with the top face on one edge;
a connecting face, if not in the first frame element, connected with at least one of the top face and the lateral face on another edge intersecting with the edge;
a top rivet hole protruding from a second top joint portion on one end of the top face; and
a lateral rivet hole protruding from a second lateral joint portion on one end of the lateral face, or the second lateral joint portion being the connecting face if there, wherein the top rivet unit and the top rivet hole, and the lateral rivet unit and the lateral rivet hole are respectively at corresponding positions so as to be tightly joined for joining the first top joint portion with the second top joint portion and the first lateral joint portion with the second lateral joint portion.

2. The easy-to-be-assembled double-face bezel structure according to claim 1, wherein the connecting face is connected with the top face and/or the lateral face of the first frame element, and a first included angle between the top face and the lateral face of the first frame element is substantially the same as a second included angle between the connecting face and the lateral face of the first frame element.

3. The easy-to-be-assembled double-face bezel structure according to claim 1, wherein the connecting face is connected with the top face and/or the lateral face of the second frame element, and a first included angle between the top face and the lateral face of the second frame element is substantially the same as a second included angle between the connecting face and the lateral face of the second frame element.

4. The easy-to-be-assembled double-face bezel structure according to claim 1, wherein at least one of the rivet holes is enlarged toward a non-joined surface of the joint portion where the rivet hole is disposed.

5. The easy-to-be-assembled double-face bezel structure according to claim 4, wherein at least one of the rivet holes has a countersink shape.

6. The easy-to-be-assembled double-face bezel structure according to claim 4, wherein a height of the corresponding rivet unit of the rivet hole is larger than a depth of the rivet hole.

7. The easy-to-be-assembled double-face bezel structure according to claim 1, wherein the first frame element and the second frame element are made of metal.

8. The easy-to-be-assembled double-face bezel structure according to claim 1, wherein, the first top joint portion and the second top joint portion form a half lap joint, and the first lateral joint portion and the second lateral joint portion form a half lap joint upon being assembled.

9. The easy-to-be-assembled double-face bezel structure according to claim 1, wherein each of the frame elements has a strip shape, an L shape or a rectangular U shape.

10. The easy-to-be-assembled double-face bezel structure according to claim 1, wherein the easy-to-be-assembled double-face bezel structure comprises two strip-shaped first frame elements and two strip-shaped second frame elements, the first frame element having two first top joint portions and two first lateral joint portions respectively on both ends, the second frame element having two second top joint portions and two second lateral joint portions respectively on both ends, and at each of four corners of the double-face bezel structure, both the first top joint portion and the second top joint portion, and the first lateral joint portion and the second lateral joint portion are tightly joined.

11. The easy-to-be-assembled double-face bezel structure according to claim 1, wherein the first frame element further comprises another top rivet unit protruding from the first top joint portion, and the second frame element further comprises another top rivet hole penetrating through the second top joint portion correspondingly.

12. The easy-to-be-assembled double-face bezel structure according to claim 1, wherein the first frame element further comprises another lateral rivet unit protruding from the first lateral joint portion, and the second frame element further comprises another lateral rivet hole penetrating through the second lateral joint portion correspondingly.

13. The easy-to-be-assembled double-face bezel structure according to claim 1, wherein the first frame element further comprises another top rivet hole penetrating through the first top joint portion, and the second frame element further comprises another top rivet unit protruding from the second top joint portion correspondingly.

14. The easy-to-be-assembled double-face bezel structure according to claim 13, wherein the additional top rivet hole is enlarged toward a non-joined surface of the first top joint portion.

15. The easy-to-be-assembled double-face bezel structure according to claim 1, wherein the first frame element further comprises another lateral rivet hole penetrating through the first lateral joint portion, and the second frame element further comprises another lateral rivet unit protruding from the second lateral joint portion correspondingly.

16. The easy-to-be-assembled double-face bezel structure according to claim 15, wherein the additional lateral rivet hole is enlarged toward a non-joined surface of the first lateral joint portion.

17. A method for assembling an easy-to-be-assembled double-face bezel structure, wherein the easy-to-be-assembled double-face bezel structure comprises at least one first frame element and at least one second frame element, each being one-piece, and wherein the first frame element comprises a top face; a lateral face connected with the top face on one edge; a connecting face, if not in the second frame element, connected with at least one of the top face and the lateral face on another edge intersecting with the edge; a top rivet unit protruding from a first top joint portion on one end of the top face; and a lateral rivet unit protruding from a first lateral joint portion being the connecting face if there, or the first lateral joint portion on one end of the lateral face; and wherein the second frame element comprises a top face; a lateral face connected with the top face on one edge; a connecting face, if not in the first frame element, connected with at least one of the top face and the lateral face on another edge intersecting with the edge; a top rivet hole protruding from a second top joint portion on one end of the top face; and a lateral rivet hole protruding from a second lateral joint portion on one end of the lateral face, or the second lateral joint portion being the connecting face if there, the top rivet unit and the top rivet hole, and the lateral rivet unit and the lateral rivet hole being respectively at corresponding positions, consisting the steps of:
placing the rivet units into the corresponding rivet holes; and
punching each of the rivet units such that the rivet unit fill the corresponding rivet hole.

18. The method for assembling the easy-to-be-assembled double-face bezel structure according to claim 17, wherein at least one of the rivet holes is enlarged toward a non-joined surface of the joint portion where the rivet hole is disposed, a height of the corresponding rivet unit of the rivet hole is larger than a depth of the rivet hole, and the punching step involves punching the rivet unit such that the rivet unit fills the enlarged portion of the corresponding rivet hole.
